(19) United States
(12) Patent Application Publication
(10) Pub. No.: US 2020/0011188 A1
(43) Pub. Date: Jan. 9, 2020

(54) BLADE FOR A GAS TURBINE ENGINE

(71) Applicant: ROLLS-ROYCE plc, London (GB)

(72) Inventor: Andrew MEKERESZ, Derby (GB)

(73) Assignee: ROLLS-ROYCE plc, London (GB)

(21) Appl. No.: 16/437,343

(22) Filed: Jun. 11, 2019

(30) Foreign Application Priority Data
Jul. 9, 2018 (GB) 1811205.2

(51) Int. Cl. F01D 5/30

(52) U.S. Cl. CPC F01D 5/3007; F05D 2220/32

(57) ABSTRACT

A blade for a gas turbine engine that includes a blade root having an asymmetric lobe.

This disclosure claims the benefit of UK Patent Application No. GB1811205.2, filed on 9 Jul. 2018, which is hereby incorporated herein in its entirety.

The present disclosure relates to a blade for a gas turbine engine.

In a gas turbine engine, blades are typically mounted on a (rotor) disc of the gas turbine engine and extend generally radially from the disc. The disc is usually secured to a shaft of the gas turbine engine to allow rotation thereof (and of the blades) about a principal rotational axis of the gas turbine engine.

In conventional bladed disc arrangements, a series of circumferentially arranged blades are mounted to the rotor disc. This is typically achieved by providing the blade with a blade root which fits within a slot provided in the disc. The blade root and slot have cooperating shapes so as to appropriately transfer forces. For example, the blade root typically comprises contact surfaces, referred to as “bedding flanks”, which are angled so as to engage corresponding surfaces of the slot provided in the disc to retain the blade against the centrifugal force acting outwardly on the blade by rotation of the disc during operation.

The blade root typically comprises a lower (radially inward facing) surface defining a base of the blade root and a pair of lobes extending across the base in a transverse direction of the blade root. Each of the lobes extends downwardly from the base of the blade root and forms a projection along the base of the blade root. Each blade root lobe has a constant longitudinal extent such that it is symmetric about a mid-plane which bisects the root and is parallel with a longitudinal direction of the blade root and the slot to which the blade root is fitted. The pair of blade root lobes is also symmetric about a mid-plane which bisects the root and is perpendicular with a longitudinal direction of the blade root and the slot to which the blade root is fitted.

Whilst this arrangement may be satisfactory, it may be desirable to provide an improved arrangement.

According to an aspect of the disclosure there is provided a blade for a gas turbine engine comprising a blade root having an asymmetric lobe. The outer geometry and/or general shape of the lobe may be asymmetric.

The Applicants have recognised that the distribution of loads across a blade root, in use, is typically inconsistent or asymmetric and that utilising an asymmetric blade root lobe may allow the outer geometry (or shape) of the lobe to be tailored to the particular loading conditions on the blade root. For example, a region or side of the lobe which experiences higher forces may be designed with a greater longitudinal extent than a region or side of the lobe which experiences lower forces. This may allow an optimal shape to be chosen which may allow stress to be reduced in the regions of concern (e.g. the bedding flanks of the blade root) with little or no increase in mass when compared to a conventional symmetric root lobe. As the mass is not increased on the blade, overall life and integrity of the disc is not compromised, yet the root stresses are reduced. Furthermore, asymmetric root lobes would not require any additional machining operations to create (compared to conventional machining operations for symmetric lobes), such that an improved blade root can be provided while maintaining ease and cost of manufacture.

The blade may comprise an aerofoil portion, a platform and a blade root. The aerofoil portion may extend radially outwardly from the platform. The blade root may extend radially inwardly from the platform.

The blade root may be configured to be inserted into a slot along a longitudinal direction. The lobe may be asymmetric about a first mid-plane which bisects the blade root. The longitudinal direction and the first mid-plane may be parallel with each other or the longitudinal direction may be contained within the first mid-plane.

The longitudinal direction may be a longitudinal direction of the slot to which the blade root is fitted in use. The longitudinal direction may be parallel with the engine axis or may be at an angle from the engine axis, e.g. an angle up to 30 degrees, e.g. 20 degrees, from the engine axis. This may be the case where the blade root (and slot) is of an “axial-type” blade root. The longitudinal direction of the slot may instead be (substantially) perpendicular to the engine axis. This may be the case where the blade root (and slot) is of a “circumferential-type” blade root.

The lobe may have first and second corresponding regions on opposite sides of the first mid-plane. The first region may be configured to experience a higher stress than the second region. The first region may have a longitudinal extent that is greater than that of the second region. By “corresponding regions” it is meant that they are located at the same positions but on opposite sides of the first mid-plane (i.e. at mirror image positions). The longitudinal extent may be a measure of the extent of material (in terms of distance) between a forward face (or edge) of the lobe and an aft face (or edge) of the lobe when measured in the longitudinal direction of the blade root (or correspondingly the slot). Each region of the corresponding regions may comprise only a single point or a plurality of points, and in the latter case the longitudinal extent may be an average longitudinal extent of the plurality of points within the region.

The blade root may have parallel sides which are both parallel with a longitudinal direction of the blade root.

The lobe may be elongate along a transverse direction which crosses the longitudinal direction. The lobe may have a variable longitudinal extent along the transverse direction.

The longitudinal extent of the lobe may taper along the transverse direction.

The mass distribution of material forming the lobe may be non-uniform along the transverse direction.

The lobe may have a forward face which is elongate along a first linear transverse direction crossing the longitudinal direction, and an aft face which is elongate along a second linear transverse direction crossing the longitudinal direction. The first linear transverse direction and the second linear transverse direction may lie in a common plane and may be non-parallel.

The blade root may have a pair of asymmetric lobes. The asymmetric lobes may be alike. Each of the asymmetric lobes may have any of the features described herein.

The pair of asymmetric lobes may comprise a front lobe and an aft lobe. The first linear transverse direction of the front lobe may be parallel with the second linear transverse direction of the aft lobe. The second linear transverse direction of the front lobe may be parallel with the first linear transverse direction of the aft lobe.

The first linear transverse direction of the front lobe and the second linear transverse direction of the aft lobe may each be perpendicular to the longitudinal direction. The second linear transverse direction of the front lobe and the first linear transverse direction of the aft lobe may each be inclined with respect to a transverse direction perpendicular to the longitudinal direction.

The lobes may taper along in opposing transverse directions. This arrangement may improve the balance of the root.

The aft lobe may taper along a direction from a first end corresponding to the pressure side of the blade to a second end corresponding to the suction side of the blade. The front lobe may taper along a direction from the second end of the blade to the first end of the blade.

The blade root may comprise a pair of lobes which are asymmetric about any plane along a transverse direction which is perpendicular to the longitudinal direction. For example, the pair of lobes may be asymmetric about a second mid-plane which bisects the blade root and which is perpendicular to and contains the longitudinal direction.

The blade may be a compressor blade, a turbine blade or a fan blade.

According to another aspect of the disclosure, there is provided a rotor disc assembly comprising a disc and one or more blades in accordance with any statement herein.

According to another aspect of the disclosure, there is provided a gas turbine engine comprising a blade in accordance with any statement herein.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments will now be described by way of example, with reference to the accompanying drawings, in which:

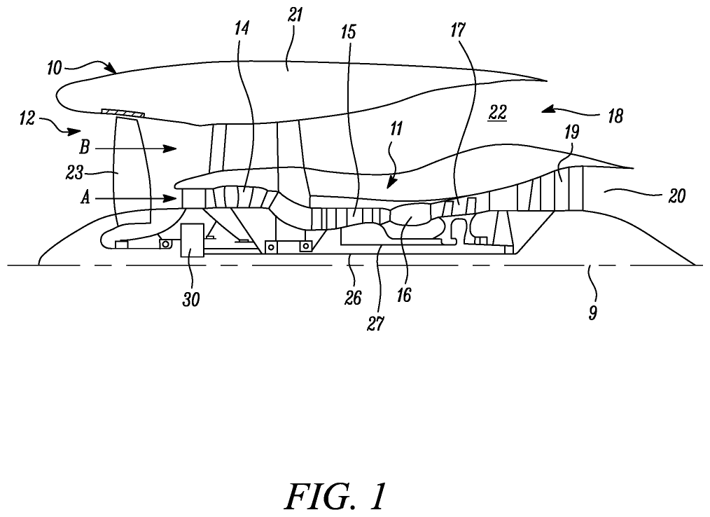

FIG. 1 is a sectional side view of a gas turbine engine;

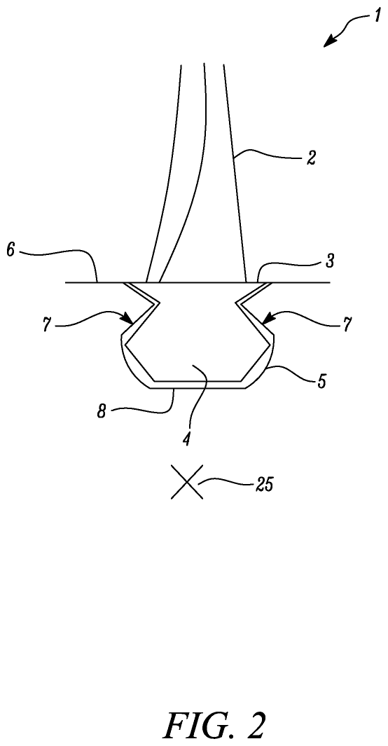

FIG. 2 schematically shows a portion of a compressor assembly of a gas turbine engine, in accordance with a previously considered arrangement;

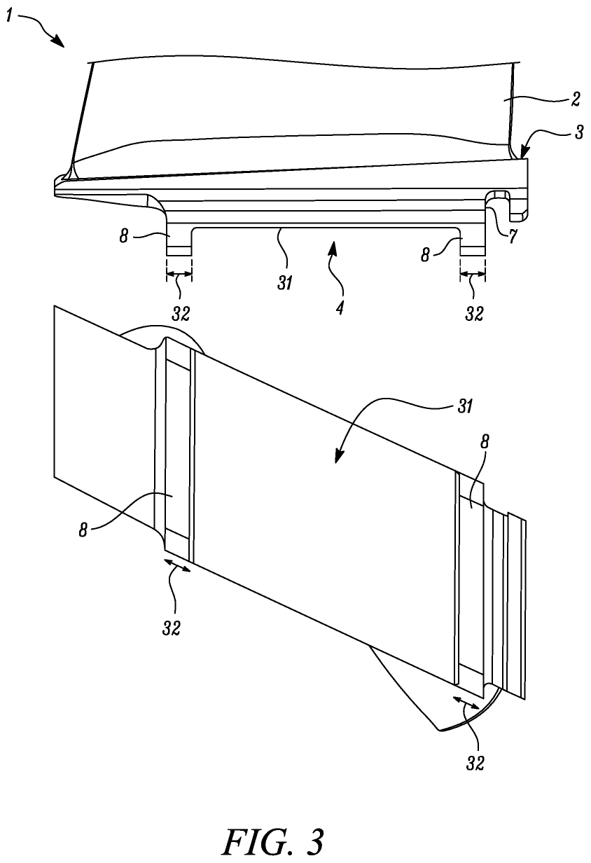

FIG. 3 shows two schematic views of a blade root having symmetric lobes in accordance with a previously considered arrangement;

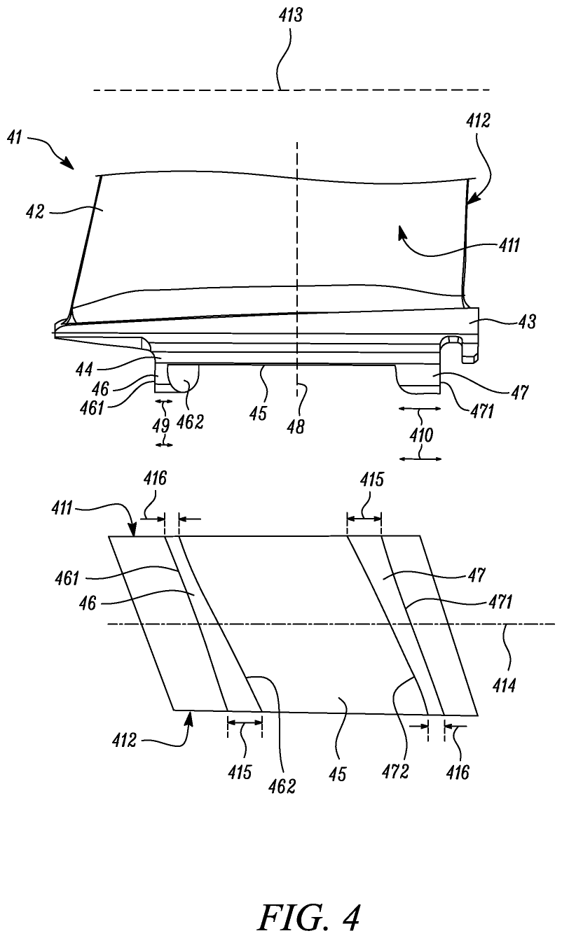

FIG. 4 shows two schematic views of a blade having asymmetric root lobes in accordance with an embodiment of the present disclosure; and

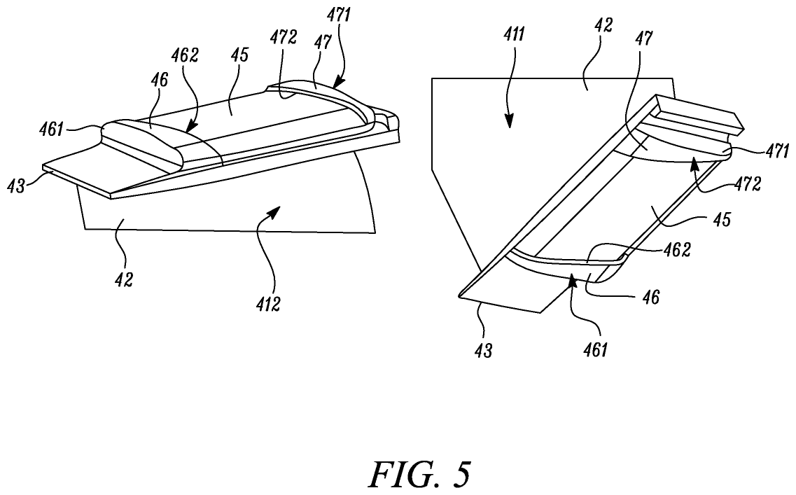

FIG. 5 schematically shows two perspective views of a blade, in accordance with the present disclosure.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclical gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclical gearbox 30 is a reduction gearbox.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

Each of the pressure compressors comprises a plurality of circumferentially arranged and radially extending compressor blades attached to one or more rotors in the form of compressor discs. Each compressor has at least one disc but may have two or more discs as appropriate. Similarly, each turbine comprises a plurality of circumferentially arranged and radially extending turbine blades arranged in one or more turbine discs. Each turbine has at least one disc, but may have two or more discs.

Referring to FIG. 2, which shows a front view of a previously considered arrangement, a compressor blade 1 comprises an aerofoil portion 2, a platform 3 and a root 4. The blade 1 is generally radially extending with the aerofoil portion 2 radially extending outwards from the platform 3 and the blade root 4 radially extending inwards from the platform 3. As shown, the compressor blade 1 is attached to the compressor disc 6 by locating the blade root 4 and securing it within a slot 5 provided in the compressor disc 6. The blade root 4 is configured to be inserted into the slot 5 along a longitudinal direction 25 of the slot 5. The blade root 4 may be an “axial-type” blade root 4 in that the longitudinal direction 25 is parallel with, or at an angle of less than 45 degrees from, the principal and rotational axis 9 (not shown) of the engine.

The slot 5 is shaped so as to receive the root 4 of the blade 1 and the root 4 engages the slot 5. As will be appreciated, during use forces are transferred between the root 4 and slot 5 via contact surfaces 7 of the blade root 4. In particular, during use the blade 1 will experience centrifugal forces acting radially outwardly on the blade 1 due to rotation of the disc 6, but will be retained to the disc 6 by virtue of the engagement between contact surfaces 7 of the blade root 4 and the slot 5.

Movement of the blade root 4 within the slot 5 is restricted (e.g. when the engine is not in use or at low rotational speeds) by a pair of lobes 8 that projects from the base (not shown) of the blade root 4 to a position proximate the bottom of the slot 5. The lobes 8 may extend to a position proximate the inner surfaces of the slot 5 to close a gap between the blade root 4 and the slot 5 to form a seal which prevents air leakage between the slot 5 and blade root 4. Each lobe is configured to engage a radially inward surface of a slot to which the blade root is fitted in use, to retain the blade to the slot.

FIG. 3 shows two schematic views, a first, side view (top of FIG. 3) and a second, bottom perspective view (bottom of FIG. 3), of a previously considered blade 1. As can be seen in FIG. 3, the blade 1 comprises a blade root 4 having a base 31 defining a lower surface of the blade root 4 and a pair of lobes 8 extending therefrom. Each lobe 8 in the pair extends in generally the same transverse direction parallel to one another and the distance by which the pair of lobes 8 project radially will typically depend on the depth of the slot 5 to which the blade 4 is fitted in use.

The lobes 8 are generally symmetric about two mid-planes. Firstly, each lobe 8 is itself symmetric about a first mid-plane that bisects the root 4 and is parallel with the longitudinal direction 25. For example, the longitudinal extent 32 of each lobe 8 is constant along the transverse direction of the blade root 4. Secondly, the pair of lobes 8 are together symmetric about a second mid-plane that bisects the base 31 of the root 4 and is perpendicular with the longitudinal direction 25.

The blade of the present invention differs from the previously considered arrangements described above with respect to FIGS. 2 and 3 in that the blade root lobes 46, 47 are asymmetric. This will now be discussed with respect to FIGS. 4 and 5.

FIG. 4 schematically illustrates a first, side view of the blade 41 at the top of FIG. 4 and a second, bottom perspective view of the blade 41 at the bottom of FIG. 4. FIG. 5 schematically illustrates two perspective views of the blade 41 of FIG. 4.

As can be seen, the blade 41 comprises an aerofoil 42, a platform 43 and a blade root 44. The root 44 extends radially inwardly from the platform 43 and is configured to be inserted into a slot along a longitudinal direction 413 of the slot. The blade has parallel sides which are each aligned with the longitudinal direction 413 for slotting the blade 41 into the slot. The root 44 comprises a base 45 defining a radially inward surface of the blade root 44 and a pair of lobes that are elongate along a transverse direction which crosses the longitudinal direction 413. The pair of lobes 46, 47 comprises a front lobe 46 at an axially forward edge of the base 45 and an aft lobe 47 at an axially rearward edge of the base 45. Each lobe 46, 47 in the pair comprises a forward face 461, 472 which is elongate along a first linear transverse direction crossing the longitudinal direction 413, and an aft face 462, 471 which is elongate along a second linear transverse direction crossing the longitudinal direction 413. The forward face and the aft face in this arrangement are perpendicular to the surface of the base 45 (although this is not required). Each lobe is configured to engage a radially inward surface of a slot to which the blade root is fitted in use, to restrict movement of the blade within the slot. Accordingly, the distance by which the pair of lobes 46, 47 extends from the base 45 will depend on the depth of the slot to which the blade root 44 is fitted in use.

As can be seen, the front lobe 46 and the aft lobe 47 are each asymmetric about a first mid-plane 414 that bisects the blade root 44. The longitudinal direction 413 and the first mid-plane 414 are parallel with each other and the longitudinal direction 413 is contained within the first mid-plane 414. In this embodiment the blade root 44 is an “axial-type” blade root, such that the first mid-plane 414 is parallel to and contains the engine axis or is at a non-perpendicular angle thereto. The first mid-plane 414 bisects the blade root 44 such that the distances along the normal from the first mid-plane 414 to the furthest edges of the blade root 44 (i.e. to the parallel sides at the outer edges of the blade root 44) are the same on both sides of the first mid-plane 414.

Each lobe 46, 47 is asymmetric inasmuch as the general overall shape, i.e. the general outer profile, is asymmetric. This is achieved in this arrangement by providing a non-uniform mass distribution of material forming the lobe 46, 47 along the transverse direction (crossing the longitudinal direction 413 about the first mid-plane 414). This may allow the geometry of the blade root lobes 46, 47 to be more appropriately tailored to the forces it experiences. This may therefore allow an optimal shape to be chosen which may allow stress to be reduced in the regions of concern with little or no increase in mass when compared to the mass of a conventional symmetric blade root lobe. As the mass is not increased on the blade, overall life and integrity of the disc is not compromised, yet the root stresses are reduced.

The outer profiles of the lobes 46, 47 are non-symmetric. In particular, the lobes are 46, 47 are asymmetric in that the first linear transverse direction and the second linear transverse direction lie in a common plane and are non-parallel. Further, the lobes 46, 47 have widths that are asymmetrical about the first mid-plane 414. That is, the longitudinal extent of each lobe 46, 47 measured along the longitudinal direction 413 of the blade root 44 and slot 5 varies asymmetrically along a transverse direction of the blade root and slot which is perpendicular to and crosses the longitudinal direction 413. In this way, the longitudinal extent of a given (and in this case each) lobe at a first distance from the first mid-plane 414 on a first side of the mid-plane 414 is greater than the longitudinal extent of the lobe at the same distance from the first mid-plane 414 on a second, opposite side of the mid-plane 414. For example, the longitudinal extent of the lobe 46, 47 at a first distal end from the first mid-plane 414 is (e.g. four times) greater than the longitudinal extent of the lobe 46, 47 at the other, second distal end from the mid-plane 414.

Designing the lobes 46, 47 to be asymmetric allows those portions of the lobes 46, 47 (and blade root 44) which experience higher forces in use to have a corresponding longitudinal extent that is greater than those portions of the lobes 46, 47 which experience lower forces.

For the front lobe 46, it has been found that the load from the aerofoil 42 and the mass of the blade root 44 is greater on the side of the lobe 46 corresponding to suction surface side 412 of the aerofoil 42 compared to the side corresponding to the pressure surface side 411 of the aerofoil 42, and accordingly the geometry of the lobe 46 is designed to accommodate for this. In particular, the longitudinal extent 415 corresponding to a high-stress region or point on the suction surface side 412 of the lobe 46 is greater than the longitudinal extent of a corresponding low-stress region or point on the opposite, pressure surface side 411 (mirror opposite side) of the lobe 46 so as to support the higher load. The longitudinal extent 415 corresponding to a high-stress region may differ by four times the longitudinal extent 49 of the lobe 46 corresponding to a low-stress region. Of course, other suitable values may be chosen depending on the circumstances and loading forces experienced.

For the aft lobe 47, it has been found that the load from the aerofoil 42 and the mass of the blade root 44 is greater on the side of the lobe 47 corresponding to pressure surface side 411 of the aerofoil 42 compared to the side corresponding to the suction surface side 412 of the aerofoil 42, and accordingly the geometry of the lobe 47 is designed to accommodate for this. In particular, the longitudinal extent 410 corresponding to a high-stress region or point on the pressure surface side 411 of the lobe 47 is greater than the longitudinal extent 416 of a corresponding low-stress region or point on the opposite, suction surface side 412 (mirror opposite side) of the lobe 47 so as to support the higher load. The longitudinal extent 410 corresponding to a high-stress region may differ by four times the longitudinal extent 416 of the lobe 47 corresponding to a low-stress region. Of course, other suitable values may be chosen depending on the circumstances and loading forces experienced.

In the arrangement of FIGS. 4 and 5, each lobe 46, 47 may be considered as “skewed” in that, for each lobe 46, 47, the forward face 461, 472 is disposed at an angle relative to the aft face 462, 471 such that the forward face and the aft face diverge at a first distal end of the lobe and converge at a second distal end of the lobe opposite the first distal end. That is, there is a tapered increase (or decrease) in the longitudinal extent of the lobe 46, 47 in a transverse direction of the blade root 44. In the arrangement of FIGS. 4 and 5, the lobes 46, 47 taper along in opposing transverse directions. It will be appreciated that in all of these arrangements the taper has the effect of creating an asymmetric lobe. It will be appreciated that the degree of the taper and the precise variation in longitudinal extent will depend on the particular application and the expected loading conditions. It will also be appreciated that the longitudinal extent may vary in other forms such as in a step-wise manner or there may be a curvature to the front face or the aft face of the (e.g. each) lobe, or both.

While the asymmetry has been described above with respect to individual lobes of the pair of lobes 46, 47, it can be seen in FIGS. 4 and 5 that the pair of lobes 46, 47 are together asymmetric about any plane, including a second mid-plane 48 which bisects the blade root, extending along a transverse direction which is perpendicular to the longitudinal direction 413.

As can be seen in FIGS. 4 and 5, the longitudinal extent 49 of the lobe at a position on a first side of the second mid-plane 48 differs from the longitudinal extent 410 of the lobe at a corresponding position (i.e. at a mirror image position) on a second, opposite side of the second mid-plane 48. This is achieved in that the first linear transverse direction of the forward face 461 of the front lobe 46 is parallel with the second linear transverse direction of the aft face 471 of the aft lobe 47. The first linear transverse direction of the front lobe 46 and the second linear transverse direction of the aft lobe 47 are each perpendicular to the longitudinal direction 413. The second linear transverse direction of the aft face 462 of the front lobe 46 is parallel with the first linear transverse direction of the front face 472 of the aft lobe 47. The second linear transverse direction of the front lobe 46 and the first linear transverse direction of the aft lobe 47 are each inclined with respect to a transverse direction perpendicular to the longitudinal direction 413.

By providing a front lobe 46 having a second linear transverse direction which is parallel with a first linear transverse direction of the aft lobe 47, manufacturing time may be reduced. This is because the number of control changes for manipulating a manufacturing tool when machining the aft face 462 of the front lobe 46 and the front face 472 of the aft lobe 47 will be reduced, thereby reducing manufacturing time. This is in contrast to hypothetical arrangements in which a more complicated shape is used to provide a similar stress benefit.

While the description refers to each lobe of a pair of lobes being asymmetric, this is not required. Only one lobe of the pair of lobes may be asymmetric. Furthermore, a blade root may have any number of lobes and there may be an asymmetry in one or more or all of those lobes.

Further, it will be appreciated that although the front lobe 46 is described as having a second linear transverse direction which is parallel with a first linear transverse direction of the aft lobe 47 to aid manufacturing, this is not required. The second linear transverse direction of the front lobe 46 and the first linear transverse direction of the aft lobe 47 may be disposed at an angle relative to each other, as desired and this may be dependent on the specific loading condition on the blade.

It will also be appreciated that although the pair of lobes 46, 47 is described as being asymmetric about a second mid-plane which bisects the blade root and is perpendicular to the longitudinal direction 413 of the slot, in alternative embodiments the pair of lobes may be symmetric. For example, for a particular loading condition, it may be (and in an embodiment is) the case that the longitudinal extents of the front lobe 46 and the aft lobe 47 taper along equally in the same transverse direction.

Although the lobes 46, 47 are shown in FIGS. 4 and 5 to extend perpendicularly from the base 45 of the blade root 44, this is not required. The lobes could extend at any suitable angle relative to the base 45, as appropriate.

It has been described that the lobes are lobes of a compressor blade. However, it should be noted that any suitable blade (e.g. a turbine blade) could be provided with an asymmetric blade root lobe.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A blade for a gas turbine engine comprising a blade root having an asymmetric lobe.

2. The blade as claimed in claim 1, wherein the blade root is configured to be inserted into a slot along a longitudinal direction, and wherein the lobe is asymmetric about a first mid-plane which bisects the blade root, wherein the longitudinal direction and the first mid-plane are parallel with each other or the longitudinal direction is contained within the first mid plane.

3. The blade as claimed in claim 2, wherein:
the lobe has first and second corresponding regions on opposite sides of the first mid plane;
the first region is configured to experience a higher stress than the second region; and
the first region has a longitudinal extent that is greater than that of the second region.

4. The blade as claimed in claim 1, wherein the blade root has parallel sides which are both parallel with a longitudinal direction of the blade root.

5. The blade as claimed in claim 2, wherein the lobe is elongate along a transverse direction which crosses the longitudinal direction, and wherein the lobe has a variable longitudinal extent along the transverse direction.

6. The blade as claimed in claim 5, wherein the longitudinal extent of the lobe tapers along the transverse direction.

7. The blade as claimed in claim 2, wherein the mass distribution of material forming the lobe is non-uniform along the transverse direction.

8. The blade as claimed in claim 5, wherein the lobe has a forward face which is elongate along a first linear transverse direction crossing the longitudinal direction, and an aft face which is elongate along a second linear transverse direction crossing the longitudinal direction, wherein the first linear transverse direction and the second linear transverse direction lie in a common plane and are non-parallel.

9. The blade as claimed in claim 1, wherein the blade root has a pair of asymmetric lobes.

10. The blade as claimed in claim 9, wherein the pair of asymmetric lobes comprises a front lobe and an aft lobe;
wherein the first linear transverse direction of the front lobe is parallel with the second linear transverse direction of the aft lobes; and
wherein the second linear transverse direction of the front lobe is parallel with the first linear transverse direction of the aft lobe.

11. The blade as claimed in claim 10, wherein:
the first linear transverse direction of the front lobe and the second linear transverse direction of the aft lobe are each perpendicular to the longitudinal direction; and
second linear transverse direction of the front lobe and the first linear transverse direction of the aft lobe are each inclined with respect to a transverse direction perpendicular to the longitudinal direction.

12. The blade as claimed in claim 9, wherein the lobes taper along in opposing transverse directions.

13. The blade as claimed in claim 12, wherein:
the aft lobe tapers along a direction from a first end corresponding to the pressure side of the blade to a second end corresponding to the suction side of the blade; and
the front lobe tapers along a direction from the second end of the blade to the first end of the blade.

14. The blade as claimed in claim 1, wherein the blade root comprises a pair of lobes which are asymmetric about any plane along a transverse direction which is perpendicular to the longitudinal direction.

15. A gas turbine engine comprising a blade as claimed in claim 1.
